(19) United States
(12) Patent Application Publication
(10) Pub. No.: US 2019/0018759 A1
(43) Pub. Date: Jan. 17, 2019

(54) SOCIALIZED SOFTWARE DEBUGGING

(71) Applicant: SAP Portals Israel Ltd., Ra'anana (IL)

(72) Inventor: Gilad Keinan, Kfar Saba (IL)

(21) Appl. No.: 15/651,163

(22) Filed: Jul. 17, 2017

(51) Int. Cl. G06F 11/36

(52) U.S. Cl. CPC G06F 11/3664; G06F 8/71; G06F 11/3636; G06F 11/362

(57) ABSTRACT

The disclosure generally describes methods, software, and systems, including a method for providing information about a debugging session state. Information associated with a current debugging state for a debugging session of a first user is received from a first device. The information is stored. A command to share the information as with second different users is received at the server from the first device. Access to the stored information and a notification that the information is available are provided to each of one or more second different devices associated with the second different users. A command provided by a second different user to obtain the information is received at the server from a given second different device. The stored information is provided to the given second different device.

### BACKGROUND

The present disclosure relates to software development and particularly debuggers. For example, software developers use debuggers and/or other tools to debug source code in order to find the root cause of a problem. Software developers can perform actions such as setting breakpoints at particular line numbers in the source code.

### SUMMARY

This disclosure generally describes computer-implemented methods, software, and systems for providing information about a debugging session state. One computer-implemented method includes: receiving, from a first device, information associated with a current debugging state for a debugging session performed by a first user; storing, at a server, the information associated with the current debugging state; receiving, at the server and from the first device, a command to share the information associated with the current debugging state with second different users; providing, to each of one or more second different devices associated with the second different users, access to the stored information associated with the current debugging state and a notification that the information associated with the current debugging state is available; receiving, at the server and from a given second different device of the one or more second different devices, a command provided by a second different user to obtain the information associated with the current debugging state; and providing, to the given second different device, the stored information associated with the current debugging state.

The foregoing and other implementations can each optionally include one or more of the following features, alone or in combination. In particular, one implementation can include all the following features:

In a first aspect, combinable with any of the previous aspects, the information associated with the current debugging state includes: thread information for a thread, including a name of the thread, a state of the thread, and a trace including current breakpoints and a list of lines visited during the debugging session; a list of variables, including for each variable, a variable name and a value; and a code reference for source code used during the debugging session, including a version of the source code and access to the source code.

In a second aspect, combinable with any of the previous aspects, the method further includes: receiving, from the given second different device, a request to play the debugging session identified by the information associated with the current debugging state; accessing the stored information associated with the current debugging state; and providing, to the given second different device and based on the stored information associated with the current debugging state, session play information enabling the debugging session to be played by a second different user on the given second different device according to the information associated with the current debugging state.

In a third aspect, combinable with any of the previous aspects, the session restore information includes rewind and play controls tied to the information associated with the current debugging state that enable the second different user to move backward and forward in the debugging session and provide additional debugging inputs.

In a fourth aspect, combinable with any of the previous aspects, the method further includes: receiving updated information associated with the current debugging state; receiving a command to store the updated information associated with the current debugging state; storing the updated information associated with the current debugging state; and providing access to the stored updated information associated with the current debugging state.

In a fifth aspect, combinable with any of the previous aspects, the method further includes: receiving, from the first device, a command to restore the debugging session to a previous place in the debugging session; accessing the stored information associated with the current debugging state; and providing, to the first device and based on the stored information associated with the current debugging state, session restore information enabling the debugging session to be restored and replayed by the first user on the first device according to the information associated with the current debugging state.

In a sixth aspect, combinable with any of the previous aspects, the method further includes: receiving, from the first device and outside of a debugger, user-provided updates to a thread or a variable included in the stored updated information associated with the current debugging state; and updating the updated information associated with the current debugging state.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for sharing debugging sessions.

FIG. 2 is a block diagram of an example system for sharing debugging sessions.

FIG. 3A is screenshot of an example user interface showing a location of source code.

FIG. 3B is screenshot of an example user interface showing a current breakpoint location.

FIG. 3C is screenshot of an example breakpoint user interface showing a breakpoint view listing breakpoints that are currently set by the user.

FIG. 3D is screenshot of an example threads user interface showing thread information for the debugging session.

FIG. 3E is screenshot of an example process user interface showing debug process information.

FIG. 3F is screenshot of an example user interface showing information for virtual machine (VM) arguments.

FIG. 3G is screenshot of an example variables user interface showing information for variables used in a method.

FIG. 3H is screenshot of an example console log user interface showing entries from a console log.

FIG. 3I is screenshot of an example connection information user interface showing remote/local connection information.

FIG. 3J is screenshot of an example overview combining features of user interfaces of FIGS. 3C, 3D, and 3G.

FIG. 4 is a flowchart of an example method for sharing debugging sessions.

FIG. 5A is a flowchart of an example method for using persisting states.

FIG. 5B is a flowchart of an example method for replaying a debugging session from a saved state.

FIG. 5C is a flowchart of an example method for staring debugging states.

### DETAILED DESCRIPTION

This disclosure generally describes computer-implemented methods, software, and systems for providing information about a debugging session state. Information associated with a current debugging state for a debugging session performed by a first user is received from a first device. The information associated with the current debugging state is stored at a server. A command to share the information associated with the current debugging state with second different users is received at the server from the first device. Access to the stored information associated with the current debugging state and a notification that the information associated with the current debugging state is available are provided to each of one or more second different devices associated with the second different users. A command provided by a second different user to obtain the information associated with the current debugging state is received at the server from a given second different device of the one or more second different devices. The stored information associated with the current debugging state is provided to the given second different device.

The subject matter described in this specification can be implemented in particular implementations so as to realize one or more of the following advantages. First, the efficiency of a software developer can be improved by providing more features for use during the debugging process. Second, statistics can be maintained regarding use by software developers when debugging code and used to determine patterns from which debugging processes can be improved.

During debugging, problematic methods or lines can be found in different places during the debugging process. For example, developer can: 1) skip line-by-line or skip all lines (e.g., run regular execution), 2) see the state of each variable on the stack at each line, and 3) examine the state of each thread (e.g., running, sleeping, or terminated) and the stack trace. In some cases, the state of a variable can be editable during a debugging session.

Breakpoints can be set in order to pause execution at a specific (e.g., numbered) line, such as not to debug the lines before the specific line. This can be beneficial if a problematic area of code is known and to allow starting from a specific point in the flow. Conditional breakpoints can be created in which debugging will stop at a given line only if a certain condition is true.

To start the debugging process, the developer can run a unit/integration test or attach to a running process and then to trigger the flow in the process (e.g., by clicking on a button in a user interface being tested and seeing what happens).

Usually developers are working in a team or task force and are responsible together on a domain, e.g., that includes a set of applications. Providing an ability to share debugging with others, as described by this disclosure, can allow an efficient way for developers to share their debugging process with other colleagues. For example, sharing a debugging process can be done when someone is stuck and does not know how to fix a particular bug. In this case, sharing the debugging session with others can make it possible for debugging to occur in a collaborative way in which the users work together.

For example, debugging processes can be replayed from the middle, as in the following. A developer may find something problematic in the middle of the flow, such as a point in the thread in which method a( ) calls method b( ), which calls method c( ), which in turn calls method d( ) as: a( )→b( )→c( )→d( ). If the developer, at method do, finds something interesting, the developer would like to retest (or to go back again) within the calling sequence or to another point, a capability for which is not provided by conventional debuggers.

Manual solutions that create a new unit test to d( ) are not feasible, because it is not easy to repeat all inputs that occurred up to the point that method d( ) is invoked. The present disclosure proposes archiving a debugging session and monitoring debug process when fixing a bug in the debug tracking system. For example, debugging processes can be socialized, meaning that a debugging session can be shared with other developers (and/or replayed by the initial developer who initiated the session). Debugging states can be persisted is as follows:

DS(Debugging State)={T,V,Code} (1)

where T is thread information for a thread, including a name of the thread, a state of the thread, and a trace including current breakpoints and a list of lines visited during the debugging session. V is a list of variables, including for each variable, a variable name and a value. Code is a code reference for source code used during the debugging session, including a version of the source code and access to the source code. In some implementations, debugging state information can also include a user-friendly name or label assigned by the first user, a description or note accompanying the information, and other description information that may be useful to other developers.

In some implementations, state information can be persisted (e.g., saved) in JavaScript Object Notation (JSON) format in a JSON storage or in a relational database, or in some other equivalent storage having associated schema that may or may not be different. Using the persisted state information, if the developer wants to go backwards or retrigger a specific debugging state of a certain timestamp, the developer can see what was persisted and apply the information in the developer's integrated development environment (IDE). If the developer would like to edit any thread or a variable state, the developer can modify the database directly, such as using JSON or eXtensible Markup Language (XML).

Moreover, the developer can share debugging state information with other colleagues who can debug from a certain point. In some implementations, the developer can choose whether or not debugging sessions are persisted automatically or upon manual selection.

The developer can reference, such as by using an issue tracking product (e.g., Jira), a particular debugging state that is used to fix a given problem (e.g., software bug), and the developer can add a new test associated with the given problem.

In order to persist a debugging state, the following information and/or any other suitable information, can be fetched from the IDE, such as manually when the developer chooses to persist or automatically if a scheduler triggers an event. Persisting can include: 1) identifying a list of threads and their stack trace; 2) identifying a list of methods and their name, value, and line number; and 3) identifying a list of variables, their names, and their values.

Application programming interfaces (APIs) for create, read, update, and delete (CRUD) can be included as client features needed to support the persisting of debugging states. CRUD capabilities can include: 1) editing any thread, method, and/or variables; 2) identifying debugging states by timestamp or by a query; 3) importing and exporting debugging states; and 4) share debugging states with a link or file.

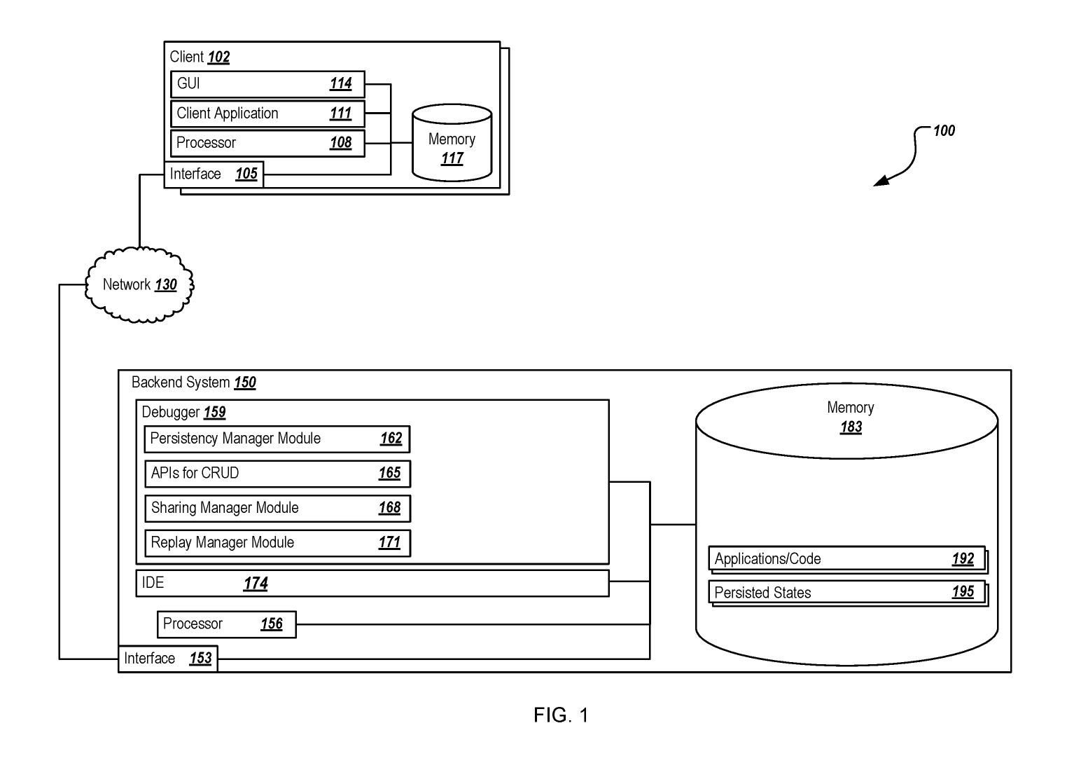

FIG. 1 is a block diagram illustrating an example system 100 for sharing debugging sessions. System 100 is a single example of a possible implementation, with alternatives, additions, and modifications possible for performing some or all of the described operations and functionality. As illustrated in FIG. 1, system 100 is associated with a system capable of performing debugging and sharing information about the debugging between plural clients 102 and using a backend system 150 via network 130. Although components are shown individually, in some implementations, the functionality of two or more components, systems, or servers may be provided by a single component, system, or server. Further, additional components may be included in alternative implementations that perform at least a part of the functions of the illustrated components. For example, at least a portion of the components illustrated in memory 183 of the backend system 150 may be stored remotely from the backend system 150, or at another location accessible via network 130.

As used in the present disclosure, the term “computer” is intended to encompass any suitable processing device. For example, client 102 and backend system 150 may be any computer or processing device such as, for example, a blade server, general-purpose personal computer (PC), Mac®, workstation, UNIX-based workstation, embedded system or any other suitable device. Moreover, although FIG. 1 illustrates particular components as a single element, those components may be implemented using a single system or more than those illustrated, as well as computers other than servers, including a server pool or variations that include distributed computing. In other words, the present disclosure contemplates computers other than general purpose computers, as well as computers without conventional operating systems. Client 102 may be any system which can request data, execute an application, and/or interact with the backend system 150. The client 102, in some instances, may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, any real-time OS among others.

The backend system 150 further includes memory 183. Memory 183 may represent a single memory or multiple memories. The memory 183 may include any memory or database module and may take the form of volatile or non-volatile memory including, without limitation, magnetic media, optical media, random access memory (RAM), read-only memory (ROM), removable media, or any other suitable local or remote memory component. The memory 183 may store various objects or data (e.g., applications/code 192 and persisted states 195), including user information, administrative settings, password information, caches, applications, backup data, repositories storing business and/or dynamic information, and any other appropriate information associated with the backend system 150 including any parameters, variables, algorithms, instructions, rules, constraints, or references thereto. Additionally, the memory 183 may store any other appropriate data, such as VPN applications, firmware logs and policies, firewall policies, a security or access log, print or other reporting files, as well as others.

As illustrated, one or more clients 102 may be present in the example system 100. Each client 102 may be associated with requests for debugger instance executions received by the backend system 150 and associated with applications/code 192. As illustrated, the client 102 may include an interface 105 for communication (similar to or different from interface 153), a processor 108 (similar to or different from processor 156), the client application 111, memory 117 (similar to or different from memory 183), and a graphical user interface (GUI) 114.

The backend system 150 may be associated with the execution of one or more debuggers 159 as described above. The debugger 159 may receive requests from client 102 (e.g., via client application 111) associated with a debugging session being controlled by debugger 159. The debugger 159 can instantiate and control the debugging session using the application programming interfaces (APIs) 165 for create, read, update, and delete operations. For example, the APIs 165 manages the metadata definitions associated with different applications/code 192 and persisted states 195.

The backend system 150 can receive information associated with a current debugging state for a debugging session performed at the client 102. On an ongoing basis, the backend system 150 can store the information as persisted states 195. The backend system 150 can receive, such as from the user of the client 102, a command to share the information associated with the current debugging state with second different users, such as users of other clients 102. The backend system 150 can provide, to each of one or more second different devices associated with the second different users, access to the stored information associated with the current debugging state (such as using a link to the information). The backend system 150 can also provide a notification that the information associated with the current debugging state is available. The backend system 150 can receive, such as from another one of the client 102, a command provided by a second different user to obtain the information associated with the current debugging state. The backend system 150 can provide the stored information associated with the current debugging state to the given second different device. The backend system 150 can, by default, save persisted states of debugging sessions on an ongoing basis and provide tools by which a user can easily share or save a current session without having to set up a process ahead of time to make it happen.

A sharing manager module 168 can perform the sharing functions of the backend system 150, including sharing stored information associated with a current debugging state when requested.

A persistency manager module 162 can manage and persist received states of a debugging session from the client 102. Persisting the received states can include updating a data store of persistent states 195, which can also be a source of information when information for a persisted state is needed, e.g., for sharing with another user.

A replay manager module 171 can handle operations such as replaying, rewinding, fast-forwarding, pause, and other operations when a debugging session is being played. The replay manager module 171 can use information from the stat store of persisted states 195 in combination with inputs received form a user who is re-playing a debugging session.

An IDE 174 can provide software development facilities to users of the client 102, such as facilities associated with the applications/code 192. In some implementations, the IDE 174 can include or invoke the debugger 159.

The user of client 102 accesses the client application 111 which can be a debugger or an IDE which provides easy-to-use access, such as by leveraging out-of-the-box and/or customized UI models for building the user interface, integrating the remote communications to the non-blocking application object within the operational code of the application.

A user interface (UI) layer can be provided to allow access to components of the applications/code 192 and features of the debugger 159. The UI layer may be provided as the client application 111 executing at the client 102, or the UI layer may be provided as a web-based application remotely accessed by the client application 111, such as where the client application 111 represents a web browser or web browsing-capable application. The client application 111 can wrap the exposed remote service calls associated with the application, and then can use efficient UI technologies such as model binding to transparently bind user interface elements against the application object's implementation in the backend application. In response to data changes within the client application 111, for example, such changes can be automatically (e.g., immediately or delayed) synchronized with the backend persistency via the debugger 159. Similarly, if the persistency data changes, the user interface elements of the client application 111 may also be updated transparently.

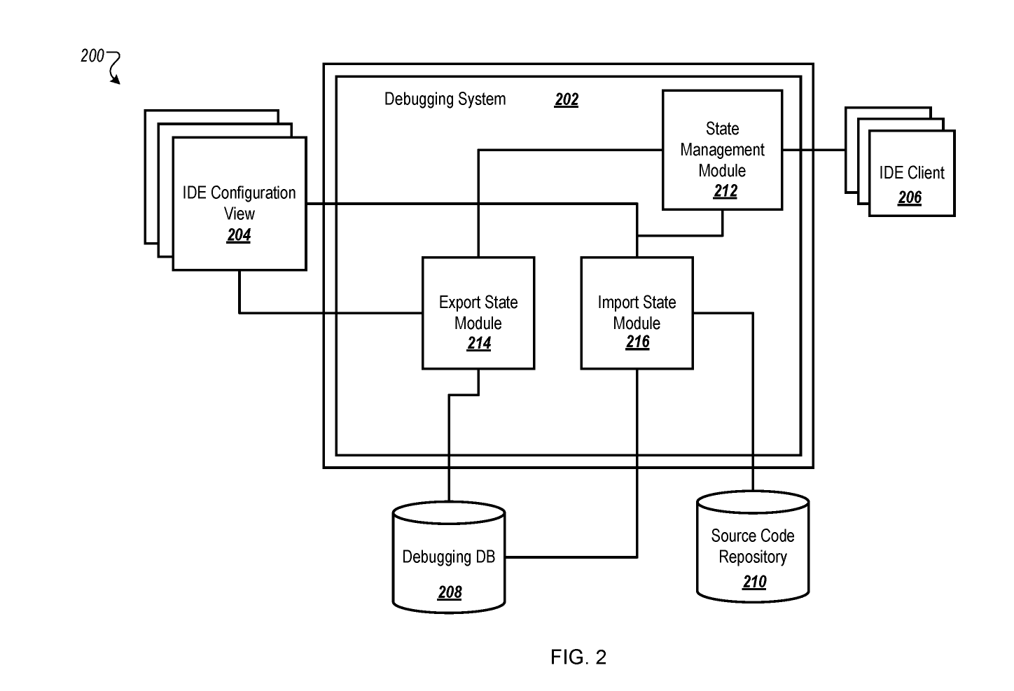

FIG. 2 is a block diagram of an example system 200 for sharing debugging sessions. The system 200 includes a debugging system 202 that can interface with IDE configuration views 204 and IDE clients 206. For example, the interaction can be provided when the debugger 159 interacts with the IDE 174 and/or with client applications 111 that include an IDE.

The debugging system 202 includes an export state module 214 that can be used for exporting information for a debugging session being performed using the debugging system 202. The debugging system 202 also includes an import state module 216 that can be used for importing information for a debugging session being performed using the debugging system 202. The export state module 214 and the import state module 216 can be implemented using the sharing manager module 168.

The debugging system 202 can use a debugging database 208 for storage of information related to the debugging session, including debugging state information for the current debugging session. The debugging database 208 can store the persisted states 195, for example. The debugging system 202 can use a source code repository 210, e.g., that can correspond to the data store of applications/code 192 and can be used for storing the source code that is used during a debugging session.

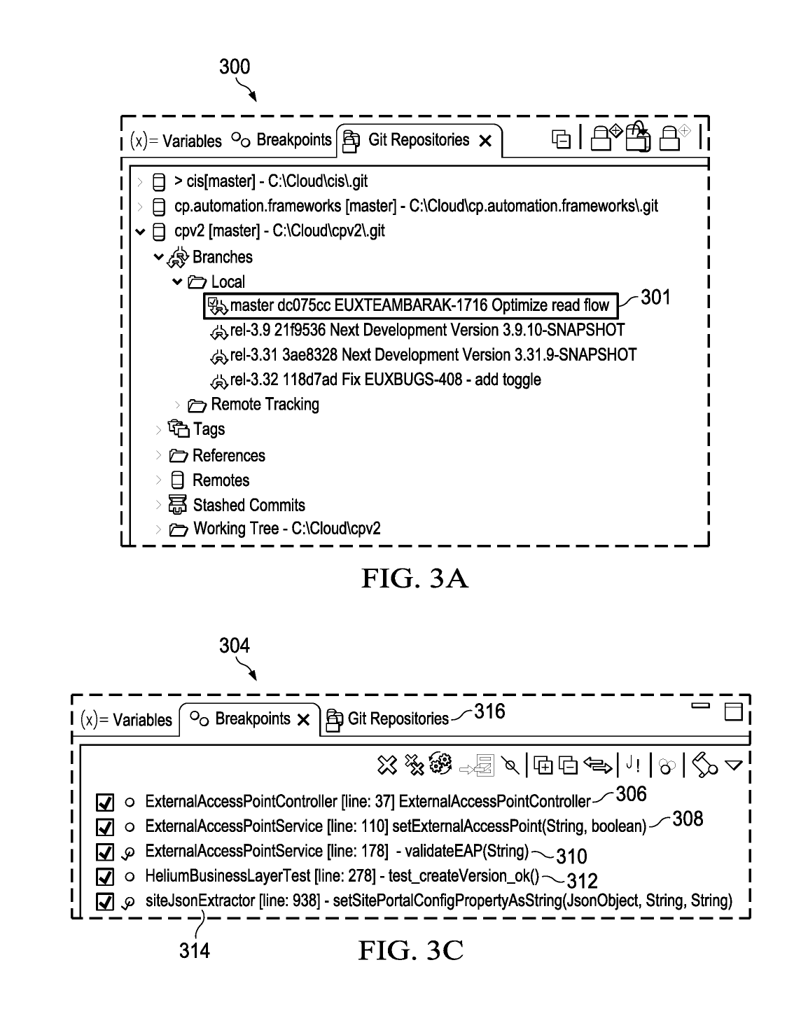

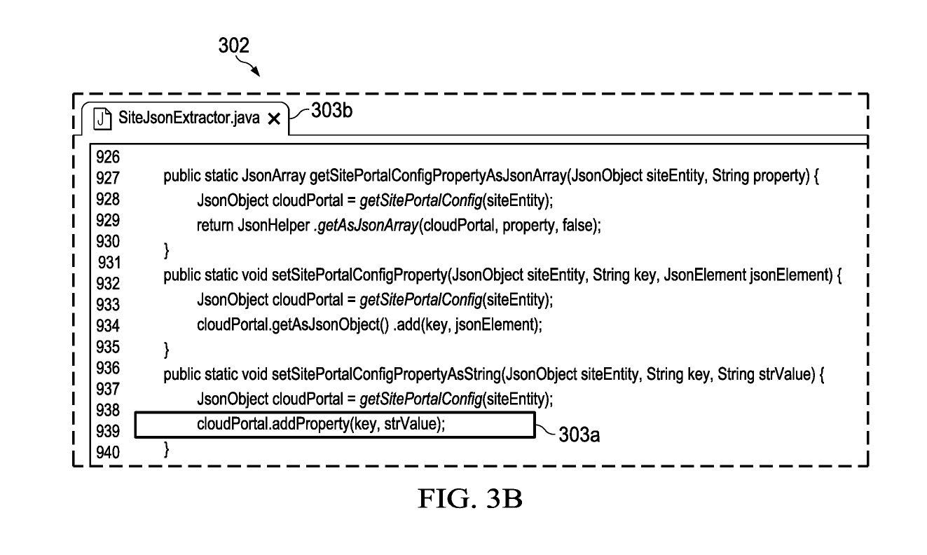

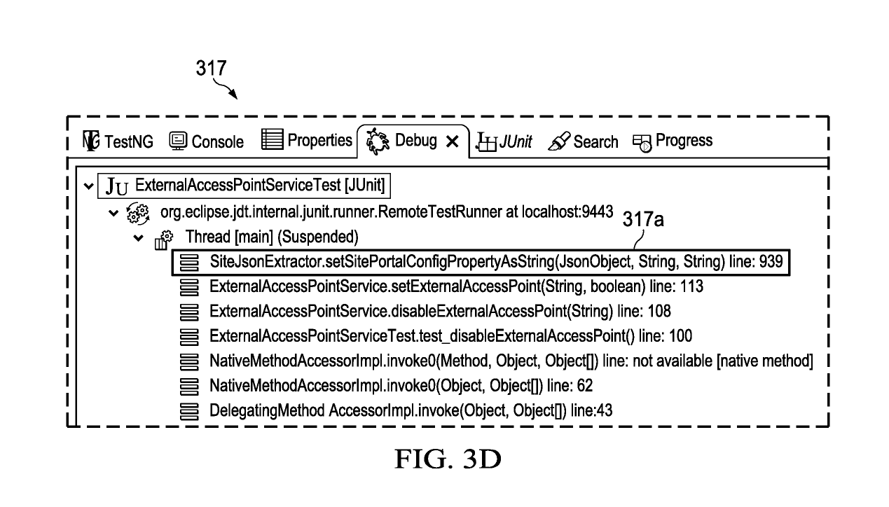

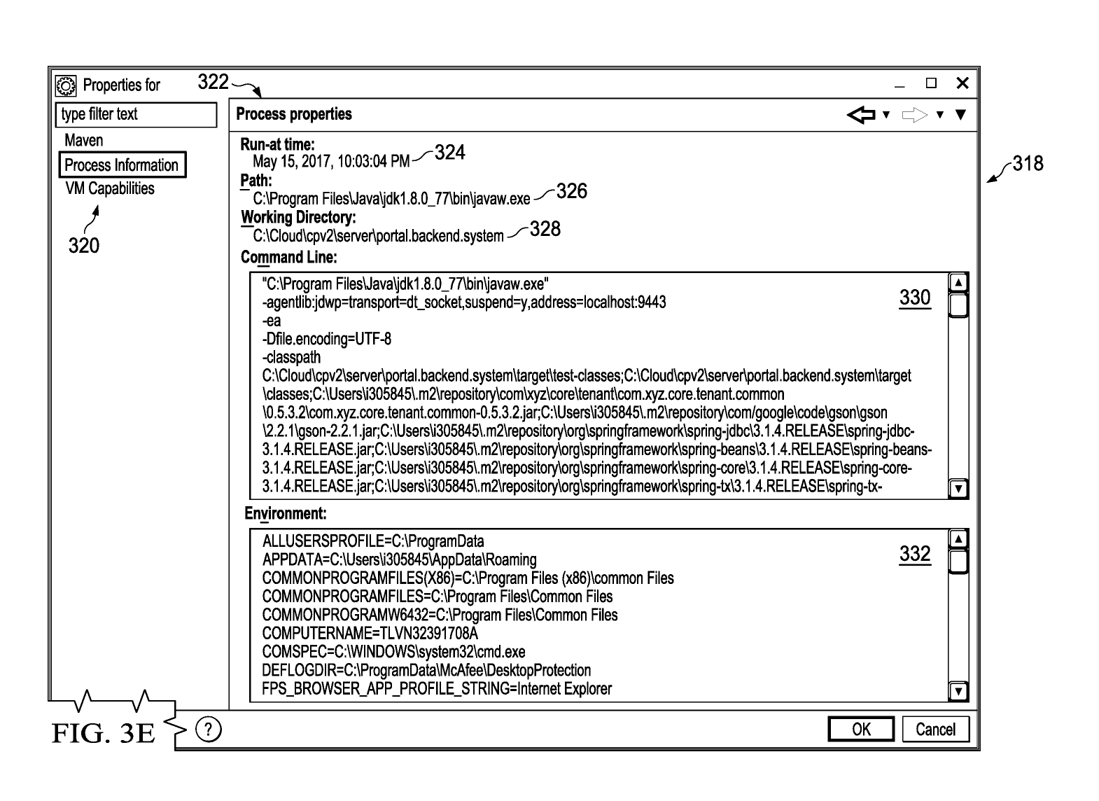

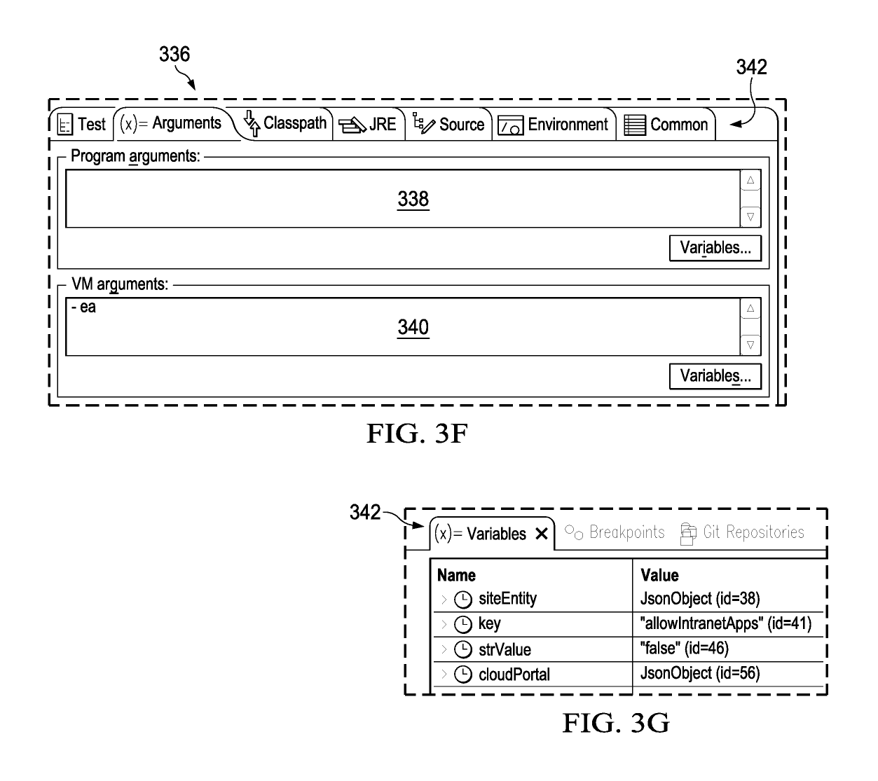

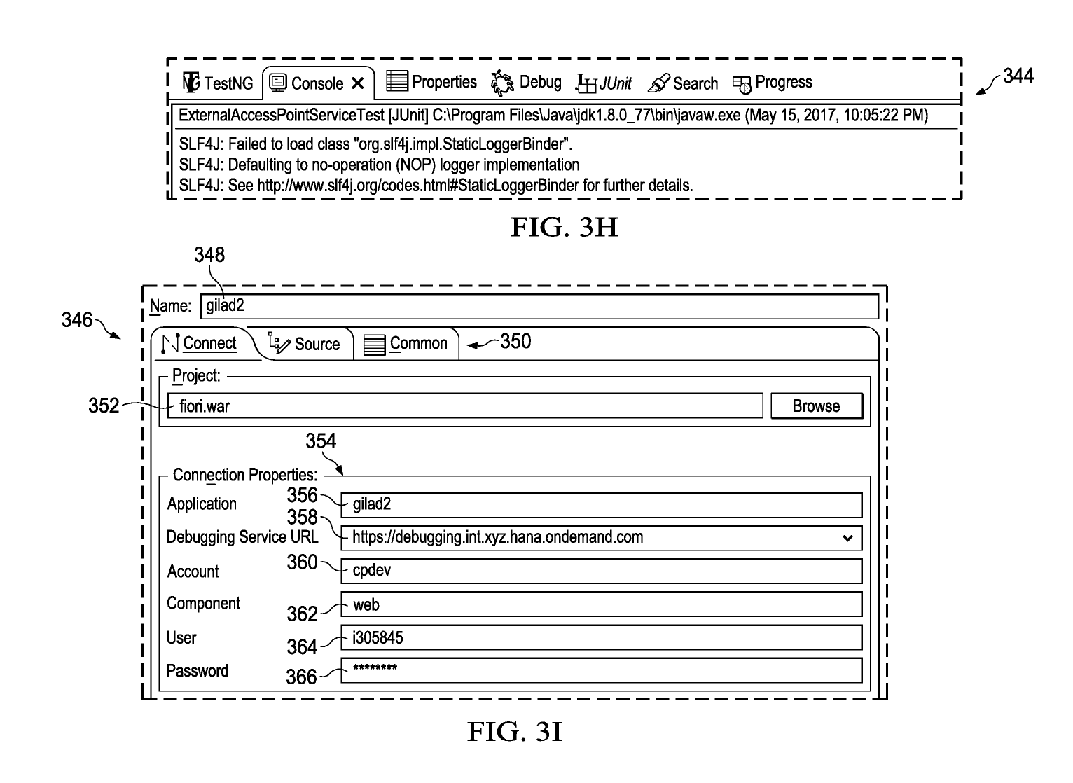

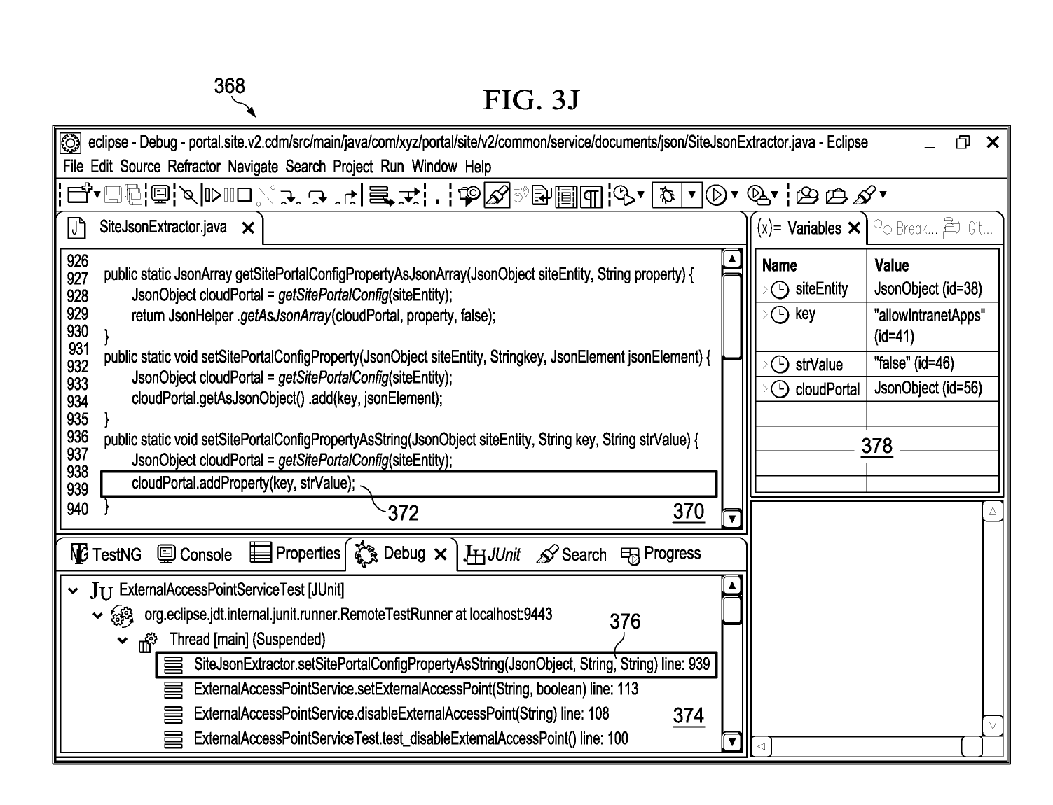

During a debugging session, a developer can have access to various user interfaces that are described below with reference to FIGS. 3A-3J. The UIs can be presented, for example, through the client applications 111 during a debugging session being executed by a developer. Other UIs are also possible, including UIs for sharing, replaying, and performing other functions associated with debugging sessions.

FIG. 3A is screenshot of an example user interface 300 showing a location of source code. A source code's location identifies or represents, for example, the location of specific source code versions 301 used during the debugging process.

FIG. 3B is screenshot of an example user interface 302 showing a current breakpoint location 303. For example, the current breakpoint location 303 identifies a location in the source code at which a current breakpoint has stopped, e.g., at a line 303a (e.g., “setSitePortalConfigPropertyAsString (JsonObject, String, String)”) in a method 303b (e.g., “SiteJsonExtractor”).

FIG. 3C is screenshot of an example breakpoint user interface 304 showing a breakpoint view listing breakpoints that are currently set by the user. For example, breakpoints 306-314 are shown as being set for the current debugging session. Breakpoint information can include, for each breakpoint, a class name, a line number, a function signature, and other information. Other information, including variable information and source code repository information, can be accessible from other tabs 316.

FIG. 3D is screenshot of an example threads user interface 317 showing thread information for the debugging session. The thread information includes information for all threads set by the user and can identify, for each thread, a thread ID, a stack trace, and a thread state. The thread information includes a line 317a that identifies the line 303a (e.g., “setSitePortalConfigPropertyAsString (JsonObject, String, String)”) and the method 303b (e.g., “SiteJsonExtractor”), which are the same line and method as described above with reference to FIG. 3B.

FIG. 3E is screenshot of an example process user interface 318 showing debug process information. The process information includes metadata 322 of the running process, including a run-at time 324, a path 326, a working directory 328, and a command line 330. Other information in addition to process information is available from options 320. An environment information area 332 lists information for the computer environment associated with the debugging session.

FIG. 3F is screenshot of an example user interface 336 showing information for virtual machine (VM) arguments. The virtual machine arguments include information 338 for program arguments and information 340 for VM arguments (e.g., “-ea”).

FIG. 3G is screenshot of an example variables user interface 342 showing information for variables used in a method. For example, the information includes a key-value pair for each of the current variables that are within scope of the current debugging session.

FIG. 3H is screenshot of an example console log user interface 344 showing entries from a console log. The console log can include log entries written to the console during the debugging session.

FIG. 3I is screenshot of an example connection information user interface 346 showing remote/local connection information. The information can include, for example, Information regarding whether the debugging is connecting to a remote machine or a local host. The information includes a connection name 348, a project name 352, and connection properties 354 that include an application 356, a debugging service URL 358, an account 360, a component 362, a user 364, and a password 366. The information can change from one system to another, therefore the information can be persisted (e.g., in a JSON format) to support adaption changes in the format. Tabs 350 can provide access to other information, such as source and common information.

FIG. 3J is screenshot of an example overview 368 combining features of user interfaces of FIGS. 3C, 3D, and 3G. The overview 368 can include: a) a code area 370 that identifies a current breakpoint 372, b) a thread area 374 identifying a current thread 376, and c) a variables area 378 identifying variables used in the current session.

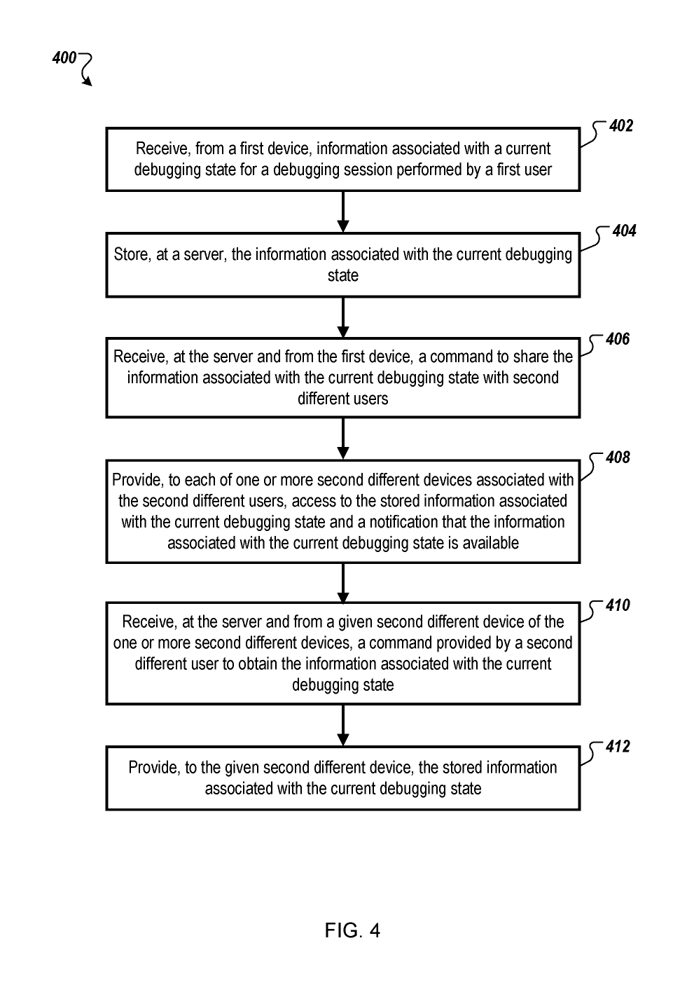

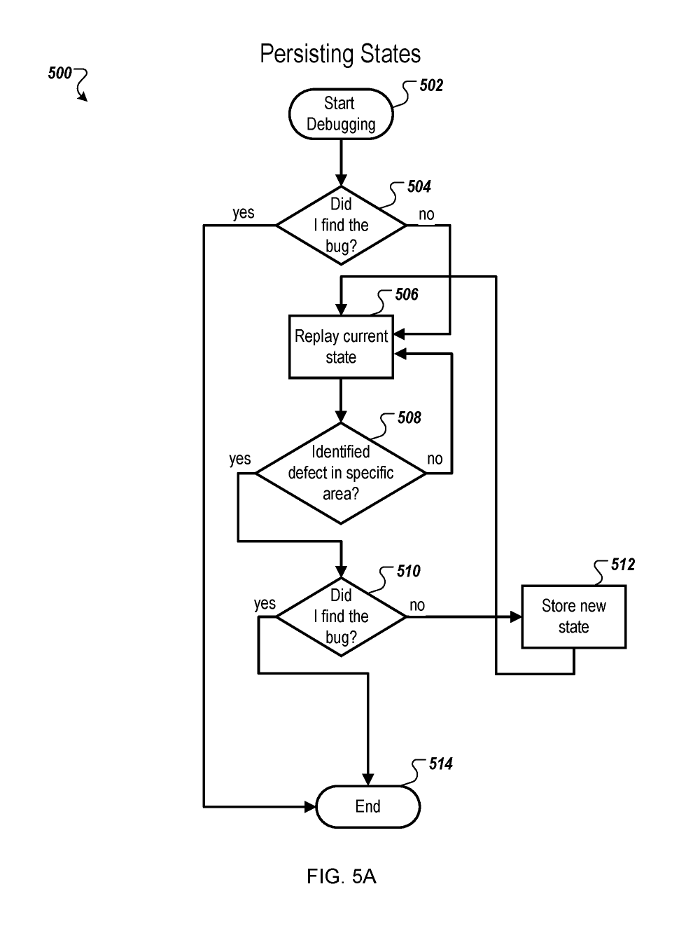

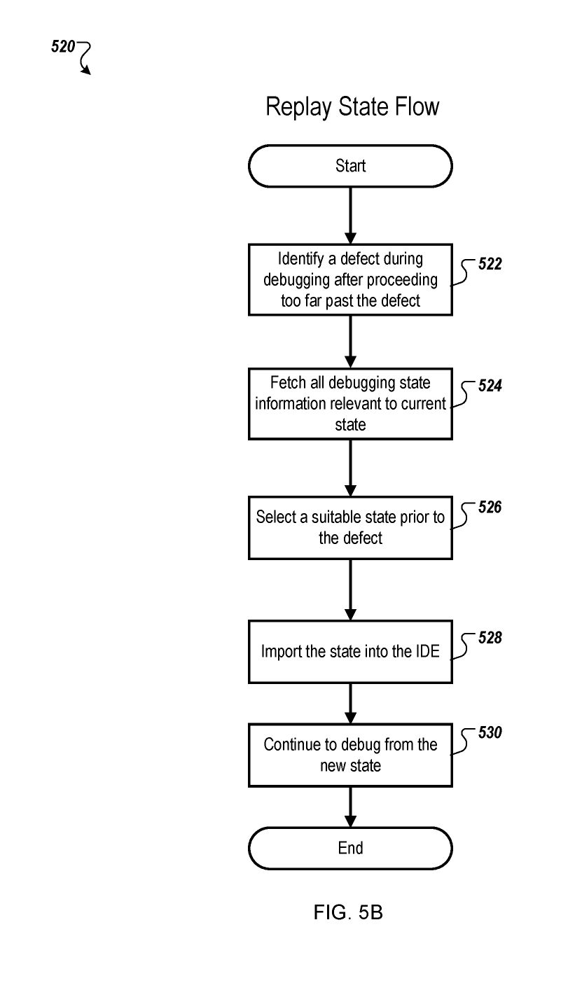

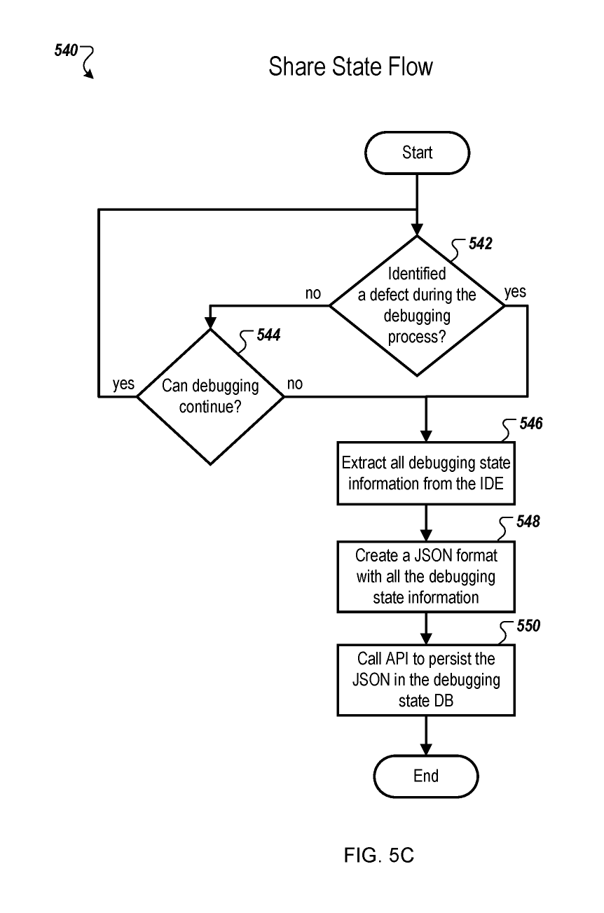

FIG. 4 is a flowchart of an example method 400 for sharing debugging sessions. For clarity of presentation, the description that follows generally describes method 400 in the context of FIGS. 1 through 3J. Additional detail regarding saving, sharing, and restoring debugging sessions is provided below with reference to FIGS. 5A through 5C.

At 402, information associated with a current debugging state for a debugging session performed by a first user is received from a first device. For example, the backend system 150 can receive information for a debugging session that a developer is performing at the client 102. The debugging session can occur, for example, using the client application 111 in communication with the debugger 159. The developer may be trying to find a bug in Application A, for example.

At 404, the information associated with the current debugging state is stored at a server. For example, the persistency manager module 162 can store information for the session in the data store of persisted states 195.

At 406, a command to share the information associated with the current debugging state with second different users is received at the server from the first device. For example, the developer can choose to share the debugging session with other developers, such as colleagues who may be able to provide insight into debugging Application A, including suggesting particular parts of the application to consider. The backend system 150, for example, can receive the command.

At 408, access to the stored information associated with the current debugging state and a notification that the information associated with the current debugging state is available are provided to each of one or more second different devices associated with the second different users. As an example, the sharing manager module 168 can send notifications to the other developers that the first user is sharing the debugging session. Each notification can be sent with a control for accessing the debugging session, such as a link to the debugging session, an identifier for accessing information stored in the data store of persisted states 195, or a file that contains the information needed so that debuggers 159 used by the colleagues can replay the debugging session.

At 410, a command provided by a second different user to obtain the information associated with the current debugging state is received at the server from a given second different device of the one or more second different devices. One of the developer's colleagues, for example, can execute the received control or click on the link associated with the debugging session.

At 412, the stored information associated with the current debugging state is provided to the given second different device. Based on the received information, the sharing manager module 168, for example, can retrieve the information associated with the current debugging state from the data store of persisted states 195 and provide the information to the client(s) 102 associated with the particular colleague.

In some implementations, the method 400 can also include steps for replaying a debugging session. For example, the backend system 150 can receive, from the given second different device such as another client 102, a request to play the debugging session identified by the information associated with the current debugging state. The request can come, for example, from the client 102 for a colleague of the developer. The sharing manager module 168, for example, can access the stored information associated with the current debugging state, such as information stored in the data store of persisted stated 195. Through the IDE 174, for example, the sharing manager module 168 can provide session play information to the other client 102. The session play information can enable the second different user (e.g., the colleague) on the given second different device to replay the debugging session according to the information associated with the current debugging state. Capabilities can also be provided for rewinding and performing other actions the debugging session. For example, the session restore information can include rewind and play controls tied to the information associated with the current debugging state that enable the second different user to move backward and forward in the debugging session and provide additional debugging inputs.

In some implementations, the method 400 can also include steps for receiving updates to a stored debugging session. For example, the backend system 150 can receive updated information associated with the current debugging state, such as additional break points to be added, breakpoints to be deleted, variables to watch, and/or other debugging actions. The backend system 150, for example, can receive a command to store the updated information associated with the current debugging state. The persistency manager module 162, for example, can then store the updated information associated with the current debugging state. The sharing manager module 168, for example, can provide access to the stored updated information associated with the current debugging state, such as by providing a link to the stored debugging session or a file containing all of the information to replay the stored debugging session.

In some implementations, the method 400 can also include steps that allow the same user to restore and replay a debugging session. For example, the backend system 150 can receive a command from the first device (e.g., the client 102) to restore the debugging session to a previous place in the debugging session. This can happen, for example, when the developer determines that the application has progressed too far beyond a point at which different debugging actions could have found a bug. The replay manager module 171, for example, can access the stored information associated with the current debugging state, such as in the data store of persisted states 195, and provide session restore information to the first device. The session restore information can enable the debugging session to be restored and replayed by the first user on the first device according to the information associated with the current debugging state.

In some implementations, the method 400 can also include steps that allow the user to update the database directly for a stored debugging session. For example, a debugger session editor (or other user interface outside of the debugger 159) can accept user-provided updates to a thread or a variable included in the stored updated information associated with the current debugging state. The debugger session editor can receive from the first device and outside of the debugger 159 and can update the updated information associated with the current debugging state. The debugger session editor can provide the option to destructively update the stored debugging session information or provide a way to leave the stored debugging session information unchanged but create a new stored debugging session.

FIG. 5A is a flowchart of an example method 500 for using persisting states. For clarity of presentation, the description that follows generally describes method 500 in the context of FIGS. 1 through 3J.

At 502, a developer can start debugging an application. For example, the developer can use the client application 111 that interacts with the debugger 159 to begin debugging an application.

At 504, the developer can determine whether a bug has been found in the application, which can happen at some time after debugging is started. As an example, the developer may spend some time, set some breakpoints, and perform other debugging actions, then subsequently realize that execution of the application has gone past a point in the execution where the developer could have discovered a reason for a bug. In another example, the developer may not detect a bug at all, but may want to repeat the debugging session in order to perform other debugging actions that may uncover the bug. If the bug has been found in a first execution of the code during the debugging session, there is no need to replay the debugging session, and the process can end at 514.

At 506, in the case that the bug was not found at 504, the developer can choose to replay the current state. This can allow the same breakpoints and other actions to replay that occurred when the debugging session was run and saved. For example, the debugger can use tools available in the IDE 174 and/or debugger 159 in order to replay the debugging session.

At 508, the developer can determine if the defect was identified in the specific area being replayed (e.g., the replayed portion of the debugging session). If the defect was not identified, then step 506 can be repeated to replay the current state. If the defect was identified, then processing can continue at step 510.

At 510, the developer can determine whether the bug has been found. If so, then the method 500 can end at 512. If the bug has not been found, then the developer can choose to store the new state at 512.

At 512, the new state can be stored, and processing can continue at step 506 at which the current state is replayed. The persistency manager module 162, for example, can store the debugging session information in the data store of persisted states 195.

FIG. 5B is a flowchart of an example method 520 for replaying a debugging session from a saved state. For clarity of presentation, the description that follows generally describes method 520 in the context of FIGS. 1, 3, and 4.

At 522, a defect is identified during debugging after proceeding too far past the defect. For example, the developer may be debugging Application A and realize that the application has executed beyond a point at which debugging action would have been useful in determining the bug.

At 524, all debugging state information relevant to current state is fetched. For example, the debugger 159 can fetch the relevant information from the current debugging session from the data store of persisted stated 195.

At 526, a suitable state prior to the defect is selected. As an example, the developer can decide on a position in the debugging state to which the execution of the application is to be rewound. This can be a place in the application that is some distance before a current breakpoint at which the debugging may currently be stopped.

At 528, the state information is imported into the IDE. For example, the replay manager module 171 can reset execution of the application at the specified state. At this time, the values of the variables and other resources under control of the application can be reset to values that were present at the time, similar to the concept of reverting back to a checkpoint.

At 530, debugging continues from the new state. For example, the developer can then use the debugger 159 to continue debugging Application A.

FIG. 5C is a flowchart of an example method 540 for staring debugging states. For clarity of presentation, the description that follows generally describes method 540 in the context of FIGS. 1, 3, and 4.

At 542, a determination is made whether a defect is identified during the debugging process. For example, the developer can decide if a bug has been determined at a current time during the debugging session.

At 544, a determination is made as to whether debugging is to continue. For example, the developer may be done debugging and may want to save the current debugging session for a later time.

At 546, all debugging state information is extracted from the IDE. For example, the persistency manager module 162 can obtain all of the current debugging session information that is currently on the IDE, such as the currently set breakpoints and any other debugging actions that have been set up by the developer.

At 548, a JSON format is created with all the debugging state information. For example, persistency manager module 162 can generate a JSON file or place the information in some other format.

At 550, an API is called to persist the JSON in the debugging state database. As an example, persistency manager module 162 can store the debugging state information in the data store of persisted states 195.

In some implementations, components of the environments and systems described above may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, components may be adapted to execute any operating system, including Linux, UNIX, Windows, Mac OS®, Java™, Android™, iOS or any other suitable operating system. According to some implementations, components may also include, or be communicably coupled with, an e-mail server, a web server, a caching server, a streaming data server, and/or other suitable server(s).

Processors used in the environments and systems described above may be a central processing unit (CPU), an application specific integrated circuit (ASIC), a field-programmable gate array (FPGA), or another suitable component. Generally, each processor can execute instructions and manipulate data to perform the operations of various components. Specifically, each processor can execute the functionality required to send requests and/or data to components of the environment and to receive data from the components of the environment, such as in communication between the external, intermediary and target devices.

Components, environments and systems described above may include a memory or multiple memories. Memory may include any type of memory or database module and may take the form of volatile and/or non-volatile memory including, without limitation, magnetic media, optical media, random access memory (RAM), read-only memory (ROM), removable media, or any other suitable local or remote memory component. The memory may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, for references thereto associated with the purposes of the target, intermediary and external devices. Other components within the memory are possible.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. Software may instead include a number of sub-modules, third-party services, components, libraries, and such, as appropriate. Conversely, the features and functionality of various components can be combined into single components as appropriate.

Devices can encompass any computing device such as a smart phone, tablet computing device, PDA, desktop computer, laptop/notebook computer, wireless data port, one or more processors within these devices, or any other suitable processing device. For example, a device may comprise a computer that includes an input device, such as a keypad, touch screen, or other device that can accept user information, and an output device that conveys information associated with components of the environments and systems described above, including digital data, visual information, or a graphical user interface (GUI). The GUI interfaces with at least a portion of the environments and systems described above for any suitable purpose, including generating a visual representation of a web browser.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although this disclosure has been described in terms of certain implementations and generally associated methods, alterations and permutations of these implementations, and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving, from a first device, information associated with a current debugging state for a debugging session performed by a first user;
storing, at a server, the information associated with the current debugging state;
receiving, at the server and from the first device, a command to share the information associated with the current debugging state with second different users;
providing, to each of one or more second different devices associated with the second different users, access to the stored information associated with the current debugging state and a notification that the information associated with the current debugging state is available;
receiving, at the server and from a given second different device of the one or more second different devices, a command provided by a second different user to obtain the information associated with the current debugging state; and
providing, to the given second different device, the stored information associated with the current debugging state.

2. The computer-implemented method of claim 1, wherein the information associated with the current debugging state includes:
thread information for a thread, including a name of the thread, a state of the thread, and a trace including current breakpoints and a list of lines visited during the debugging session;
a list of variables, including for each variable, a variable name and a value; and
a code reference for source code used during the debugging session, including a version of the source code and access to the source code.

3. The computer-implemented method of claim 1, further comprising:
receiving, from the given second different device, a request to play the debugging session identified by the information associated with the current debugging state;
accessing the stored information associated with the current debugging state; and
providing, to the given second different device and based on the stored information associated with the current debugging state, session play information enabling the debugging session to be played by a second different user on the given second different device according to the information associated with the current debugging state.

4. The computer-implemented method of claim 3, wherein the session restore information includes rewind and play controls tied to the information associated with the current debugging state that enable the second different user to move backward and forward in the debugging session and provide additional debugging inputs.

5. The computer-implemented method of claim 1, further comprising:
receiving updated information associated with the current debugging state;
receiving a command to store the updated information associated with the current debugging state;
storing the updated information associated with the current debugging state; and
providing access to the stored updated information associated with the current debugging state.

6. The computer-implemented method of claim 1, further comprising:
receiving, from the first device, a command to restore the debugging session to a previous place in the debugging session;
accessing the stored information associated with the current debugging state; and
providing, to the first device and based on the stored information associated with the current debugging state, session restore information enabling the debugging session to be restored and replayed by the first user on the first device according to the information associated with the current debugging state.

7. The computer-implemented method of claim 1, further comprising:
receiving, from the first device and outside of a debugger, user-provided updates to a thread or a variable included in the stored updated information associated with the current debugging state; and
updating the updated information associated with the current debugging state.

8. A system comprising:
memory storing:
information associated with states of debugging sessions; and
a server performing operations comprising:
receiving, from a first device, information associated with a current debugging state for a debugging session performed by a first user;
storing, at a server, the information associated with the current debugging state;
receiving, at the server and from the first device, a command to share the information associated with the current debugging state with second different users;
providing, to each of one or more second different devices associated with the second different users, access to the stored information associated with the current debugging state and a notification that the information associated with the current debugging state is available;
receiving, at the server and from a given second different device of the one or more second different devices, a command provided by a second different user to obtain the information associated with the current debugging state; and
providing, to the given second different device, the stored information associated with the associated with the current debugging state.

9. The system of claim 8, wherein the information associated with the current debugging state includes:
thread information for a thread, including a name of the thread, a state of the thread, and a trace including current breakpoints and a list of lines visited during the debugging session;
a list of variables, including for each variable, a variable name and a value; and
a code reference for source code used during the debugging session, including a version of the source code and access to the source code.

10. The system of claim 8, the operations further comprising:
receiving, from the given second different device, a request to play the debugging session identified by the information associated with the current debugging state;
accessing the stored information associated with the current debugging state; and
providing, to the given second different device and based on the stored information associated with the current debugging state, session play information enabling the debugging session to be played by a second different user on the given second different device according to the information associated with the current debugging state.

11. The system of claim 10, wherein the session restore information includes rewind and play controls tied to the information associated with the current debugging state that enable the second different user to move backward and forward in the debugging session and provide additional debugging inputs.

12. The system of claim 8, the operations further comprising:
receiving updated information associated with the current debugging state;
receiving a command to store the updated information associated with the current debugging state;
storing the updated information associated with the current debugging state; and
providing access to the stored updated information associated with the current debugging state.

13. The system of claim 8, the operations further comprising:
receiving, from the first device, a command to restore the debugging session to a previous place in the debugging session;
accessing the stored information associated with the current debugging state; and
providing, to the first device and based on the stored information associated with the current debugging state, session restore information enabling the debugging session to be restored and replayed by the first user on the first device according to the information associated with the current debugging state.

14. The system of claim 8, the operations further comprising:
receiving, from the first device and outside of a debugger, user-provided updates to a thread or a variable included in the stored updated information associated with the current debugging state; and
updating the updated information associated with the current debugging state.

15. A non-transitory computer-readable media encoded with a computer program, the program comprising instructions that when executed by one or more computers cause the one or more computers to perform operations comprising:
receiving, from a first device, information associated with a current debugging state for a debugging session performed by a first user;
storing, at a server, the information associated with the current debugging state;
receiving, at the server and from the first device, a command to share the information associated with the current debugging state with second different users;
providing, to each of one or more second different devices associated with the second different users, access to the stored information associated with the current debugging state and a notification that the information associated with the current debugging state is available;
receiving, at the server and from a given second different device of the one or more second different devices, a command provided by a second different user to obtain the information associated with the current debugging state; and
providing, to the given second different device, the stored information associated with the current debugging state.

16. The non-transitory computer-readable media of claim 15, wherein the information associated with the current debugging state includes:
thread information for a thread, including a name of the thread, a state of the thread, and a trace including current breakpoints and a list of lines visited during the debugging session;
a list of variables, including for each variable, a variable name and a value; and
a code reference for source code used during the debugging session, including a version of the source code and access to the source code.

17. The non-transitory computer-readable media of claim 15, the operations further comprising:
receiving, from the given second different device, a request to play the debugging session identified by the information associated with the current debugging state;
accessing the stored information associated with the current debugging state; and
providing, to the given second different device and based on the stored information associated with the current debugging state, session play information enabling the debugging session to be played by a second different user on the given second different device according to the information associated with the current debugging state.

18. The non-transitory computer-readable media of claim 17, wherein the session restore information includes rewind and play controls tied to the information associated with the current debugging state that enable the second different user to move backward and forward in the debugging session and provide additional debugging inputs.

19. The non-transitory computer-readable media of claim 15, the operations further comprising:
receiving updated information associated with the current debugging state;
receiving a command to store the updated information associated with the current debugging state;
storing the updated information associated with the current debugging state; and
providing access to the stored updated information associated with the current debugging state.

20. The non-transitory computer-readable media of claim 15, the operations further comprising:
receiving, from the first device, a command to restore the debugging session to a previous place in the debugging session;
accessing the stored information associated with the current debugging state; and
providing, to the first device and based on the stored information associated with the current debugging state, session restore information enabling the debugging session to be restored and replayed by the first user on the first device according to the information associated with the current debugging state.
